(19) United States
(12) Patent Application Publication
(10) Pub. No.: US 2025/0246970 A1
(43) Pub. Date: Jul. 31, 2025

(54) DRIVE UNIT FOR A DRIVE TRAIN TEST BENCH FOR TESTING A MOTOR VEHICLE DRIVE TRAIN, AND DRIVE TRAIN TEST BENCH

(71) Applicant: ZF Friedrichshafen AG, Friedrichshafen (DE)

(72) Inventors: Roland Kristl, Wegscheid (DE); Stefanie Nodes, Obernzell (DE)

(73) Assignee: ZF Friedrichshafen AG, Friedrichshafen (DE)

(21) Appl. No.: 18/856,094

(22) PCT Filed: Apr. 4, 2023
(86) PCT No.: PCT/EP2023/058840

§ 371 Date: Oct. 11, 2024

(30) Foreign Application Priority Data
Apr. 11, 2022 (DE) 10 2022 203 613.1

(51) Int. Cl. H02K 7/102; G01M 13/025; H02K 7/00

(52) U.S. Cl. CPC H02K 7/102; G01M 13/025; H02K 7/006

(57) ABSTRACT

A drive unit is provided for a drive train test bench for testing a drive train of a motor vehicle. The drive unit has a frame, an electric motor with a motor shaft, a clutch, and a drive output shaft, where the electric motor is arranged on the frame and the drive output shaft is mounted to rotate in a bearing of the frame. The motor shaft can be connected rotationally fixed to the drive output shaft by means of the clutch. The drive unit also has a brake having a first friction partner that is a radial outside of the clutch and having a second friction partner that is at least one brake pad. The invention also relates to a corresponding drive train test bench.

### RELATED APPLICATIONS

This application claims the benefit under 35 U.S.C. § 371 as a U.S. National Phase Application of application no. PCT/EP2023/058840, filed on 4 Apr. 2023, which claims the benefit of German Patent Application no. 10 2022 203 613.1, filed on 11 Apr. 2022, the contents of which are hereby incorporated herein by reference in their entireties.

### FIELD OF THE DISCLOSURE

The invention relates to a drive unit for a drive train test bench for testing a motor vehicle drive train, and to a corresponding drive train test bench.

### BACKGROUND

Test benches for transmissions and drive trains, for the testing of motor vehicle transmissions or of complete motor vehicle drive trains, have long been known from the prior art. Such test benches are used, for example, for quality control, in order to recognize functional disorders in drive trains at an early stage by means of a series of load tests. For example, typical functional disorders occur due to components affected by play, such as gearwheels, synchronous rings, synchronizing bodies, disk clutch disks, and shafts which are out of line and can be excited into vibrations. In the context of such functional testing, as a rule the acoustic behavior and the shifting quality are tested. Moreover, however, such test benches are also used in the development and continual improvement of motor vehicle drive trains.

In this connection DE 43 28 537 C2 describes a test bench for transmissions, with a first servomotor that serves as the drive motor, and a second servomotor that serves as a braking motor. The drive motor is connected by way of a clutch to a drive input shaft of a motor vehicle transmission to be tested and among other things is controlled as to its rotation speed by a PC so that any desired rotation speed variations can be simulated. The braking motor is connected by way of a further clutch to a drive output shaft of the motor vehicle transmission to be tested. The rotation speed of the braking motor is also controlled by the PC. The rotation speed variations simulated by the PC are rotation speed variations measured in real driving tests. Thus, by virtue of DE 43 28 537 C2 the motor vehicle transmission can be tested before it is fitted into a motor vehicle.

Furthermore, from DE 10 2016 224 138 A1 a drive unit of a drive train test bench with an electric motor is known, wherein the electric motor has a housing with a front and a rear yoke, whose yoke arms extend in each case radially sideways from the electric motor. The front yoke is arranged in the area of a front bearing of the motor shaft and the rear yoke is arranged in the area of a rear bearing of the motor shaft. In that way a comparatively high rigidity and vibration damping can be ensured so that the drive unit can produce high rotation speeds in excess of 25,000 rpm. Thus, the drive unit is particularly suitable for the testing of electrical drive trains.

Moreover, it is known that with the drive train test benches described a brake disk can be arranged on the motor shaft of the drive motor or at some other location in the drive train, whose rotation can be blocked by a brake caliper. In that way, the axial fitting space required and the torsional rigidity are reduced, so that undesired vibrations can occur.

Finally, from DE 10 2020 203 071 A1 a drive train test bench for electric motor vehicle transmissions is known, which comprises a test bench electric motor whose motor shaft can be coupled directly or by way of a drive train to a drive output shaft of the electric motor vehicle drive unit. On the motor shaft or in the drive train a torque sensor is arranged and the motor shaft or the drive train can be rendered rotationally fixed by a locking device. Either the motor shaft of the test bench electric motor or the drive train connected coaxially to the motor shaft of the test bench electric motor comprises a clamping device which is coaxial with the motor shaft or drive train, with a radial clamping surface radially surrounding the rotation axis of the motor shaft or the drive train, which surface is enclosed by a clamping ring. In the release position there is an annular gap between the clamping ring and the radial clamping surface. On the other hand, in a locking position the clamping ring clamps the radial clamping surface, which cannot then rotate.

However, the known motor vehicle test benches have the disadvantage that they either have to be refitted in a time-consuming manner when, instead of testing a drive train under rotation, a so-termed Stall Torque test is to be carried out, in which only a maximum torque with no rotation is applied, or if in the release position they have only a comparatively small air gap substantially narrower than 1 mm, so that measurements during rotation can be affected adversely.

### SUMMARY

A purpose of the present invention is to propose an improved drive unit for a drive train test bench for testing a motor vehicle drive train.

According to the invention, this objective is achieved by a drive unit for a drive train test bench for testing a motor vehicle drive train and a drive train test bench as disclosed herein. Further embodiments and advantageous design features will be apparent from the present disclosure.

The invention relates to a drive unit for a drive train test bench for testing a motor vehicle drive train, comprising a rack frame, an electric motor with a motor shaft, a clutch, and a drive output shaft, wherein the electric motor is arranged on the frame, wherein the drive output shaft is held and able to rotate in a bearing of the frame, and wherein the motor shaft can be connected rotationally fixed to the drive output shaft by means of the clutch. The drive unit according to the invention is characterized in that the drive output unit also comprises a brake whose first friction partner is a radially outside portion of the clutch and whose second friction partner is at least one brake pad.

Thus, the invention describes a drive unit which is designed to be used as part of a drive unit test bench, namely the drive unit thereof, wherein the drive unit test bench is in turn designed for the testing of a motor vehicle drive train. The drive unit test bench is in this case not only capable of testing complete motor vehicle drive trains, but also in particular testing individual or several parts of the motor vehicle drive train combined in a module. The motor vehicle drive train, or the part or parts of the motor vehicle drive train, thus constitute the object to be tested.

The motor vehicle drive train can just as well be an electric-motor-powered motor vehicle drive train as a conventional motor vehicle drive train.

In particular, however, the object to be tested is an electric drive motor of an electrically powered axle module that comprises an electric drive motor, a transmission, and two wheel shafts. In the latter case, two drive units according to the invention can be used, so that one drive unit can be provided for each of the two wheel shafts.

The drive unit comprises first a rack frame which is advantageously made of a particularly rigid material such as a cast mineral composite, in particular with a metallic skeleton structure.

The frame preferably comprises a holder for the electric motor so that the motor can be arranged on the frame, in particular a particularly strong and rigid holder, for example with comparatively large contact surfaces on the frame for the electric motor.

Furthermore, the frame also has bearings for the drive output shaft and especially also for the motor shaft. Thus, the drive output shaft and particularly also the motor shaft are held by the frame rigidly and with minimal vibration.

The electric motor supplies the mechanical power in the form of a torque and a rotation speed, so that the test object can be tested while rotating. Electric motors can be made comparatively compact and especially compared with internal combustion engines they have a broad spectrum of rotation speeds and advantageously maintain the maximum torque over a wide rotation speed range.

Advantageously, an inverter is associated with the electric motor. The inverter is for example of three-phase design.

For its part, the electric motor has a motor housing that accommodates the electric motor. The motor housing is of cylindrical shape, for example.

The motor housing can also be water-cooled.

Via the motor shaft, the electric motor can then supply the mechanical power in the form of a rotation speed and a torque.

By means of the clutch, the motor shaft can be connected rotationally fixed to the drive output shaft.

Correspondingly, the clutch also allows the motor shaft to be decoupled from the drive output shaft so that, for example, the electric motor or the drive output shaft can each be removed individually from the frame and replaced.

Advantageously, the drive output shaft has at its axial end facing away from the electric motor and toward the test object a connector, for example in the form of a flange or an interlocking clutch, in order to make a rotationally fixed connection to the test object.

According to the invention, it is now provided that the drive unit also comprises a brake, whose first friction partner is a radially outside part of the clutch and whose second friction partner is at least one brake pad. This, firstly, has the advantage that without fitting effort and the associated fitting time—during which the drive unit would of course not be available for testing test objects—pure torque measurements with no rotation speed can be carried out. A further advantage is that in the released position the at least one brake pad can be distanced far enough away from the outside of the clutch so that the rotation behavior is not influenced while making measurements when there are rotation speeds. For example, by means of an appropriate mechanism the at least one brake pad can be moved into contact with the outside of the clutch and moved away from it.

According to a preferred embodiment of the invention, it is provided that the brake comprises two second friction partners which are held by a brake frame floating on the outside of the clutch. In that way, the outside of the clutch can be clamped for example on two opposite sides, whereby the braking force applied can be increased. Since the two second friction partners are fitted in a floating manner, there is also no need for elaborate adjustment or positioning of the second friction partners relative to the first friction partner, either in the actuated or in the released state.

The two second friction partners are advantageously two brake pads.

In a particularly preferred embodiment of the invention, it is provided that the brake frame is arranged in a floating manner on a side-plate of the electric motor. Since the brake frame is held in a floating manner, the second friction partners do not have to be arranged individually floating on the brake frame, but rather, they can also be arranged floatingly by virtue of the floating fitting mode of the brake frame. In this case, the brake frame is advantageously a metallic frame with a corresponding mechanism that enables simultaneous actuation of the two second friction partners.

Since the brake frame is arranged on the side-plate of the electric motor, on the one hand it is held firmly and in a stable manner on the electric motor, and on the other hand it is already arranged in the area of the motor shaft and thus also close to the clutch whose outside is the first friction partner.

According to a further particularly preferred embodiment of the invention, it is provided that the brake frame at least partially surrounds the clutch radially. This means that the brake frame is arranged radially around the clutch and in particular takes up no axial fitting space. An axial extension is, as a rule, disadvantageous because thereby undesired elasticities are introduced into the drive train, which can result in vibrations that in turn have an adverse effect on the measurements and tests being carried out. Moreover, since the brake frame does not co-rotate with the clutch, no imbalances or vibrations occur due to the mass of the brake frame and the second friction partners.

In a further preferred embodiment of the invention, it is provided that the brake can be actuated hydraulically. For example, for that purpose the brake can include a hydraulic reservoir, a hydraulic cylinder and a piston arranged in the hydraulic cylinder, which actuates the brake when acted upon by an appropriate hydraulic pressure in the hydraulic cylinder. During its actuation the brake pads are moved, for example, along a linear guide to the outer circumference of the clutch and pressed against it so that a correspondingly large static friction is produced in order to establish a rotationally fixed connection.

According to another preferred embodiment of the invention, it is provided that the drive unit also comprises a torque-measurement flange. The torque-measurement flange is arranged in the drive train, advantageously in the area between the clutch and the test object.

All the torques transmitted always pass via the torque-measurement flange. Thus, the torque acting between the clutch, or between the electric motor and the test object, can be determined reliably at any time.

The rotation speed of the electric motor is advantageously determined by its control electronic system, in particular the three-phase inverter. From the rotation speed and the torque, for example the power can be determined.

In a further preferred embodiment of the invention, it is provided that the clutch is in the form of a flange connection. A flange connection allows the reliable transmission even of large and very large torques. Furthermore, a flange connection can be released comparatively simply, so that the drive output shaft and the electric motor are decoupled from one another and can, for example, be replaced.

According to a further preferred embodiment of the invention, it is provided that the electric motor is in the form of a three-phase synchronous motor.

Synchronous motors as a rule are very well suited for operating at high rotation speeds, in particular as also occur in motor vehicle drive trains powered by electric motors.

The invention further relates to a drive train test bench comprising at least one drive unit according to the invention. Accordingly, the advantages already mentioned in connection with the drive unit according to the invention also extend to the drive train test bench according to the invention.

Advantageously, the drive train test bench comprises a drive unit for each drive output shaft of the test object. In addition, advantageously the drive train test bench also comprises a holder for a test object, on which the drive train test bench can be arranged as firmly and rigidly as possible.

### BRIEF DESCRIPTION OF THE DRAWINGS

Below, the invention is explained with reference to the example embodiments illustrated in the figures.

The figures show:

FIG. 1: As an example, and illustrated schematically, a possible embodiment of a drive unit according to the invention.

FIG. 2: a sectional view of the drive unit of FIG. 1.

The same objects, functional units and comparable components are denoted by the same indexes in both figures. As regards their technical features, these objects, functional units and comparable components are designed identically unless otherwise stated explicitly or implied in the description.

### DETAILED DESCRIPTION

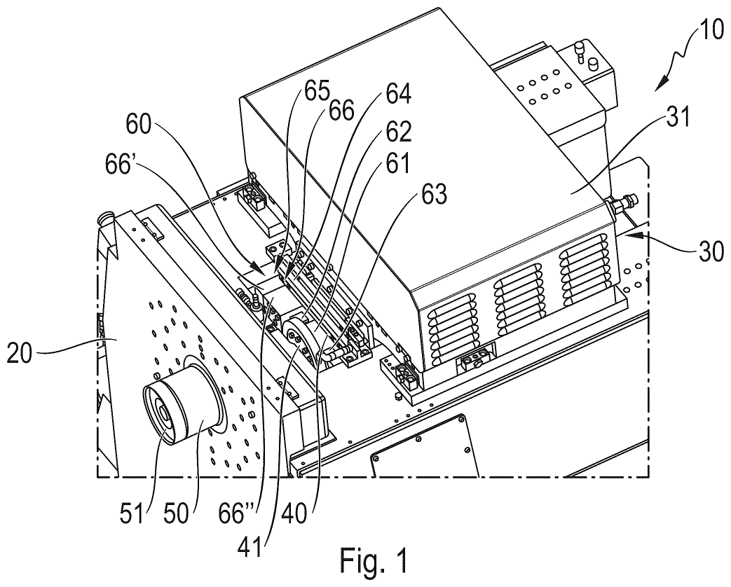

FIG. 1 shows, as an example and schematically, a possible embodiment of a drive unit 10 according to the invention. The drive unit 10 comprises a rack frame 20, an electric motor 30 (concealed in the FIG. 1 illustration), a clutch 40, a drive output shaft 50 and a brake 60.

In this example, the frame 20 consists of a cast mineral composite in which a metallic skeleton structure is cast. In that way the frame 20 is comparatively rigid and effectively prevents the occurrence of vibrations.

In this example, the electric motor 30 is in the form of a three-phase synchronous motor and is arranged between two side-plates of the frame. Associated with the electric motor 30 there is a terminal box 31 which receives the electric cables for supplying the electric motor 30 with power. In this example an inverter for controlling the electric motor 30 is arranged in a separate switch cabinet (not shown in FIG. 1).

An output shaft (concealed in the FIG. 1 illustration) of the electric motor 30 is connected via the clutch 40 to the drive output shaft 50. The drive output shaft 50 is mounted to rotate in the frame 20 and has at its axial end facing toward the test object (not shown in FIG. 1) a flange connector 51.

In addition, the drive unit 10 comprises a torque-measurement flange 41 which is arranged drivingly between the clutch 40 and the drive output shaft 50. In that way all the torques transmitted from the drive output shaft 50 to the clutch 40 or vice-versa are transmitted by way of the torque-measurement flange 41. Accordingly, these torques can be determined by the torque-measurement flange 41.

The brake 60 comprises a first friction partner 61, which consists of the radial outside 62 of the clutch 40. In addition, in this example the brake 60 comprises two second friction partners 62, 63 which are in the form of so-termed brake pads 62, 63.

The brake pads 62, 63 can be arranged on a brake frame 64 and can be actuated in the direction toward the clutch 40. For its part, the brake frame 64 is arranged radially around the clutch 40 and is attached in a floating manner to a side-plate of the electric motor 30.

In this example, the brake 60 can be actuated hydraulically by a cylinder-piston aggregate (not shown in FIG. 1), so that in the actuated condition of the brake 60 the brake pads 62, 63 are pressed against the radial outside of the clutch 40 and hold it rotationally fixed under static friction.

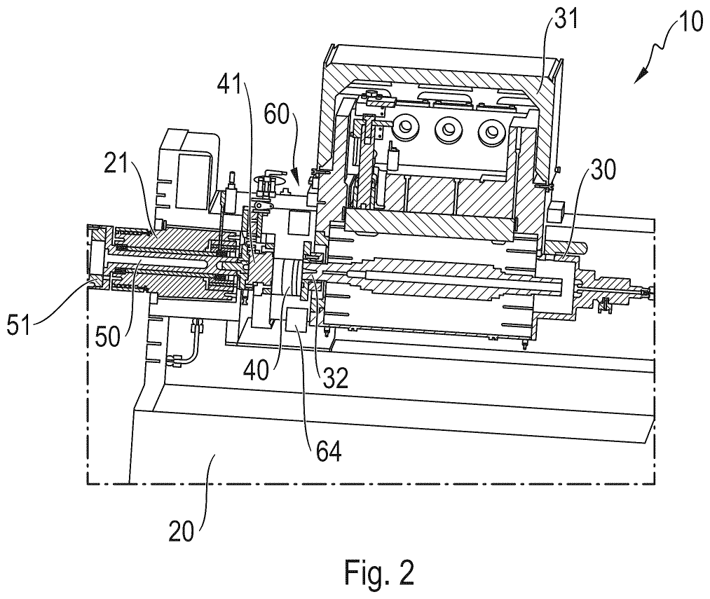

FIG. 2 shows the already described drive unit 10 of FIG. 1 in section. The already described constituents of the drive unit can be seen again here, namely the rack frame 20, the electric motor 30, the clutch 40, the drive output shaft 50 and the brake 60.

The terminal box 51 is arranged above the electric motor 30. The output shaft 32 of the electric motor 30 is connected to the drive output shaft 50 by way of the clutch 40. The drive output shaft 50 is mounted to rotate in the frame by virtue of the bearing 21 and has a flange connector 51 at its axial end facing toward the test object (not shown in FIG. 1).

The torque-measurement flange 41 is drivingly arranged between the clutch 40 and the drive output shaft 50.

Also, to be seen is the brake frame 64 which surrounds the clutch 40 radially and is arranged in a floating manner on a side-plate of the electric motor.

### INDEXES

10 Drive unit
20 Rack frame
21 Bearing
30 Electric motor, three-phase synchronous motor
31 Terminal box
32 Output shaft
40 Clutch
41 Torque-measurement flange
50 Drive output shaft
51 Flange connector
60 Brake
61 First friction partner, the radial outside of the clutch
62 Second friction partner, brake pad
63 second friction partner, brake pad
64 Brake frame

1. A drive unit (10) configured for a drive train test bench for testing a motor vehicle drive train, the drive unit comprising:
a rack frame (20) having a bearing;
an electric motor (30) on the rack frame and having a motor shaft;
a clutch (40) having a radial outside portion;
a drive output shaft (50) held rotatably in the bearing of the frame (20); and
a brake (60) having a first friction partner (61) that is the radial outside portion (61) of the clutch (40) and having a second friction partner (62, 63) that is at least one brake pad (62, 63);
wherein the motor shaft can be connected rotationally fixed to the drive output shaft (50) by means of the clutch (40).

2. The drive unit 10 according to claim 1, wherein the brake has two second friction partners (62, 63) each held in a floating manner by a brake frame (64) on the outside (61) of the clutch (40).

3. The drive unit (10) according to claim 2, wherein the brake frame (64) is arranged floatingly on a side-plate of the electric motor (30).

4. The drive unit (10) according to claim 2, wherein the brake frame (64) at least partially surrounds the clutch (40) radially.

5. The drive unit (10) according to claim 1, wherein the brake (60) is configured to be actuated hydraulically.

6. The drive unit (10) according claim 1, wherein the drive unit (10) further comprises a torque-measurement flange (41).

7. The drive unit (10) according to claim 1, wherein the clutch (40) is in the form of a flange connection.

8. The drive unit (10) according to claim 1, wherein the electric motor (30) is in the form of a three-phase synchronous motor (30).

9. A drive train test bench comprising at least one drive unit (10) according to claim 1.
